(19) United States
(12) Patent Application Publication
(10) Pub. No.: US 2023/0008568 A1
(43) Pub. Date: Jan. 12, 2023

(54) LIGHTING AND/OR SIGNALING DEVICE FOR A MOTOR VEHICLE AND A LIGHT GUIDE THEREFOR

(71) Applicant: VARROC LIGHTING SYSTEMS, S.R.O., Jicina (CZ)

(72) Inventors: Nitesh SHAH, Pune (IN); Manipal Reddy Sooram, Pune (IN)

(21) Appl. No.: 17/842,076

(22) Filed: Jun. 16, 2022

(30) Foreign Application Priority Data
Jul. 9, 2021 (IN) 202121030936

(51) Int. Cl. F21S 43/241; F21S 43/245; F21S 43/31; F21S 43/40; F21V 8/00

(52) U.S. Cl. CPC F21S 43/241; F21S 43/245; F21S 43/315; F21S 43/40; G02B 6/0053; G02B 6/0051

(57) ABSTRACT

A lighting and/or signaling device for a motor vehicle. Further, the device includes a light guide having a light incident region, a first optical region, a second optical region, and a third optical region. Further, the first optical region is configured to receive and redirect incident light rays from the light incident region to the second optical region as a first set of light rays. Further, the second optical region is configured to receive the first set of light rays, refract a first portion thereof towards an exit facet and reflect a second portion thereof towards the third optical region as a second set of light rays. Further, the third optical region is configured to receive the second set of light rays and is configured to reflect the second set of light rays towards an exit facet of the third optical region.

### CROSS-REFERENCE TO RELATED APPLICATIONS AND PRIORITY

The present application claims priority from Indian patent application no. 202121030936 filed on 9 Jul. 2021.

### TECHNICAL FIELD

The present subject matter described here, in general relates to a field of external lighting for motor vehicles, more particularly to a lighting assembly comprising a light guide.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

An external vehicle lighting device may include a lighting device such as Headlamps, Tail lamps, DRLs, Fog lamps, and the like. Further, the external vehicle lighting device may include a signalling devices such as turn signal lamps, blinkers, and the like. The external vehicle lighting device may comprise a plurality of light sources, a primary optical element such as a light guide, a secondary optical element such as a reflector, and an output lens. Further, the light emitted by the light source may be guided by the light guide and simultaneously reflected to the exit via the output lens, to illuminate an area in front of the vehicle.

One of such lighting devices is disclosed in CN110715257A by Valeo Lighting Hubei Technical Ct Co Ltd. CN'257 patent discloses a light guide device comprising a plurality of plate-shaped sections. Further, the light guide comprises an incident area, a first optical zone, a second optical zone and a third optical zone. The incident area comprises a collimating portion. Further, the first optical zone which is adjacent to the incident zone comprises a first reflective wall which faces the second optical zone, and is configured to transmit light rays to the second optical zone. The second optical zone comprises a second reflective wall configured to receive and emit at least the light reflected from the first reflective wall to the environment. The second reflective wall faces the third optical zone which is configured to receive light from the second reflective wall and transmits the said received light towards the environment.

Another such lighting device is disclosed in U.S. Pat. No. 7,661,860B2 by Valeo Vision SA. US'860 patent relates to a lighting and/or signalling device for a motor vehicle for lighting in a longitudinal emission direction. The lighting and/or signalling device comprises at least one light source emitting light rays and at least one light guiding sheet in which the light rays issuing from the light source spread by successive reflections, such that the guide sheet comprises at one end a reflective layer so as to redirect the light rays into the at least one sheet, and in that an output contour the sheet, at the end remote from the reflective layer, comprises a reflective profile, in particular inclined relative to the longitudinal axis of said sheet, so as to reflect the light rays reflected generally in an emission direction which is substantially parallel to said longitudinal axis.

However, in the existing art, the light only exits from one designated portion or region, which results in limited area of illumination. Therefore, there is an utmost need of an improved lighting device/signalling device with a light guide that alleviates at least the drawbacks/limitations/challenges of the conventional art.

### SUMMARY

This summary is provided to introduce concepts related to a lighting and/or signaling device for a motor vehicle and a light guide therefor and the concepts are further described below in the detailed description. This summary is not intended to identify essential features of the claimed subject matter nor is it intended for use in determining or limiting the scope of the claimed subject matter.

The present subject matter relates to a lighting and/or signaling device for a motor vehicle. The lighting and/or signaling device may include at least one light guide. Further, the at least one light guide may include a light incident region. The light guide may further include a first optical region, wherein the first optical region may be configured to receive incident light rays from the light incident region and redirect the incident light rays from the light incident region in a downstream direction as a first set of light rays. The light guide may further include a second optical region provisioned with an optical structure arranged downstream to the first optical region. The second optical region may be configured to receive the first set of light rays from the first optical region. Further, the second optical region may be configured to refract a first portion of the first set of light rays towards an exit facet thereof, and simultaneously reflect a second portion of the first set of light rays towards the downstream direction as a second set of light rays. Further, the light guide may include a third optical region arranged downstream to the second optical region. The third optical region may be configured to receive the second set of light rays reflected by the second optical region and reflect the second set of light rays as a third set of light rays. Further, the third set of light rays exits through an exit facet of the third optical region as exiting light rays.

In an embodiment, the second optical region and the third optical region may be enabled with a total internal reflection surfaces, wherein the total internal reflection surfaces are configured to reflect the light rays towards the downstream direction.

In an embodiment, the second optical region may be provisioned with an optical structure, wherein the optical structure may be configured to refract the first portion of the first set of light rays towards the exit and simultaneously configured to reflect a second portion of the first set of light rays towards downstream direction as a second set of light rays.

In an embodiment, the optical structure may be formed by an array of triangular prismatic structure, wherein the triangular prismatic structure may further comprise a reflective side, a refractive side, and a reflective plane. Further, the refractive side and the reflective side may be separated by the reflective plane.

In an embodiment, the lighting and/or signaling device may further include an optical element, wherein the optical element may include an optic surface positioned in front of the exit facet of the second optical region. The optic surface may be configured to receive the first portion of first set of light rays from the exit facet of the second optical region.

In an embodiment, the optic surface may include a light diffusing surface, wherein the light diffusing surface may be configured to refract the first portion of the first set of light rays exiting from the exit facet of the second optical region parallel to the exiting light rays exiting from exit facet of the third optical region.

In an embodiment, the third optical region may include an optical structure, wherein the optical structure may further include a plurality of reflective elements which enables reflection of the second portion of first set of light rays towards the exit facet of the third optical region as a third set of light rays. In one embodiment, one of the reflective elements may be configured to receive and reflect the second set of light rays towards the exit facet, and wherein the other reflective element may be configured to receive and reflect the second set of light rays towards an internal reflective surface of the third optical region, as the third set of light rays.

In an embodiment, the first portion of the first set of light rays exiting through an exit facet of the second optical region and the second set of light rays exiting an exit facet of the third optical region as an exiting light rays collectively forms exiting light rays to illuminate an area in front of the lamp.

### BRIEF DESCRIPTION OF DRAWINGS

The detailed description is described with reference to the accompanying Figures.

FIG. 1(a), 1(b), 1(c), and 1(d) illustrates complete assembly (100) of a light guide, in accordance with an embodiment of the present subject matter.

FIG. 2 illustrates a sectional view (200) of the light guide, in accordance with an embodiment of the present subject matter.

FIG. 3 illustrates an expanded view (300) of a second optical region of the light guide, in accordance with an embodiment of the present subject matter.

FIG. 4 illustrates an expanded view (400) of a third optical region of the assembly, in accordance with an embodiment of the present subject matter.

FIG. 5 illustrates a ray diagram (500) of the light rays in the light guide, in accordance with an embodiment of the present subject matter.

FIG. 6 illustrates a sectional view (600) of the light guide coupled with an optical element, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments.” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

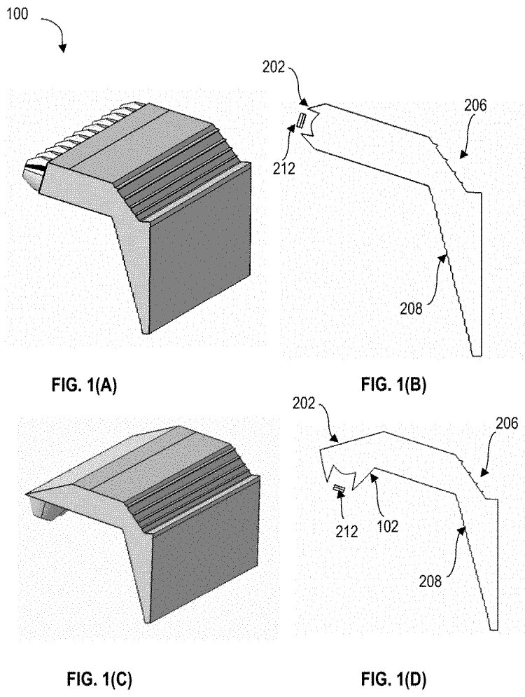

Now, referring to FIGS. 1(a), 1(b), 1(c), and 1(d), a complete assembly (100) of a light guide is illustrated, in accordance with an embodiment of the present subject matter. In an embodiment, the light guide may be assembled in a vehicle lighting and/or a signalling device for a motor vehicle.

In one embodiment, referring to FIGS. 1(a) and 1(b), a direct type of light guide is illustrated. In another embodiment, referring to FIGS. 1(c) and 1(d), an indirect type of light guide is illustrated.

In one embodiment, referring to FIGS. 1(b) and 1(d), it can be seen that the direct type and indirect type of light guide may comprise a first optical region (202), a second optical region (206), a third optical region (208) and a light incident region (212) the details of which is described in detail in subsequent paragraphs of the present disclosure. Further, referring to FIG. 1(b), it can be seen that the light incident region (212) may be directly affixed to the first optical region (202), thereby forming a direct type of light guide. Further, in another embodiment, referring to FIG. 1(d), it can be seen that the light incident region (212) may be affixed at a region (102) that separates the light incident region (212) from the first optical region (202), thereby forming an indirect type of light guide.

It must be noted herein that although the present subject matter covers both the indirect and direct type of light guide described above, however, hereinafter the subject matter is described referring to only the indirect type of light guide for the sake of brevity.

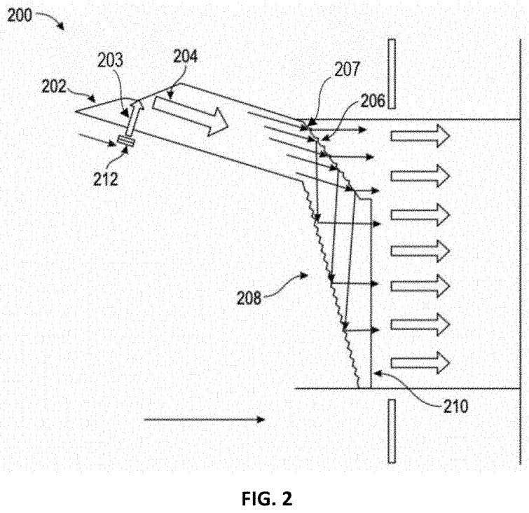

FIG. 2 illustrates a sectional view (200) of the light guide, in accordance with an embodiment of the present subject matter.

As shown in FIG. 2, the light guide may include a first optical region (202), a second optical region (206), a third optical region (208), and a light incident region (212). In one embodiment, the light incident region (212) may include a light source capable of generating incident light rays (203) which may be received by the first optical region (202). In one embodiment, the second optical region (206) may be positioned downstream to the first optical region (202). Further, the third optical region (208) may be positioned downstream to the second optical region (206). In one embodiment, the first optical region (202), the second optical region (206), and the third optical region (208) may be manufactured as a single part structure, to enable ease of assembly. Further, the single part structure may be manufactured using injection moulding process.

In one embodiment, the first optical region (202) may be equipped with a collimator (not shown in figure). In one embodiment, the second optical region (206) and the third optical region (208) may be total internal reflection (TIR) surfaces enabled to undergo total internal reflection phenomenon for reflecting the light rays within the light guide.

In one embodiment, the first optical region (202), the second optical region (206) and the third optical region (208) may be manufactured from material selected from but not limited to optical grade transparent Plastic like Polycarbonate, PMMA, Silicon, and the like. Further, the optical grade transparent plastic comprises Optically polished surface, which may be used for the higher reflections.

In one embodiment, the collimator as well as the first optical region (202) may be configured to redirect the incident light rays (203) from the light incident region (212) towards the second optical region (206) as a first set of light rays (204). Further, the second optical region (206) may be configured to receive the first set of light rays (204) from the first optical region (202) and refract a first portion of the first set of light rays (204) towards the exit facet (207). The second optical region (206) may further be configured to reflect a second portion of the first set of light rays to the third optical region (208), as a second set of light rays. Further, the third optical region (208) may reflect the second set of light rays towards the exit facet (210) of the third optical region (208).

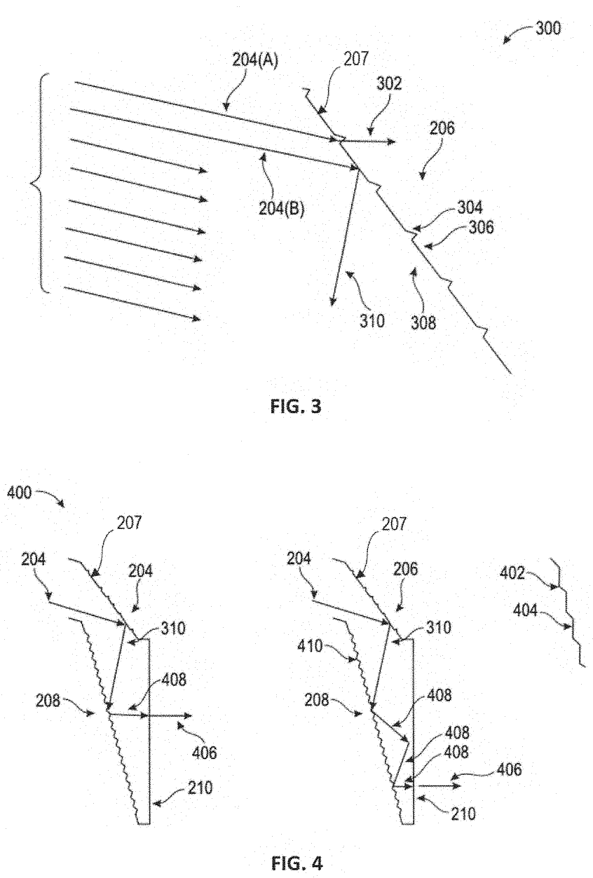

Now, referring to FIG. 3, an expanded view (300) of a second optical region (206) of the light guide is illustrated, in accordance with an embodiment of the present subject matter. As shown, the light guide may be enabled with an optical structure. Further, the optical structure may be formed by an array of triangular prismatic structure.

In one embodiment, the triangular prismatic structure may comprise a reflective side (304), a refractive side (306), a reflective plane (308). Further, the reflective side (304) and the refractive side (306) may be separated by a reflective plane (308).

In one embodiment, the reflective side (304) and the reflective plane (308) may be configured to receive the second portion (204(b)) of the first set of the light rays (204). Further, the reflective side (304) and the reflective plane (308) may be configured to reflect the second portion (204(b)) of the first set of the light rays (204) towards the third optical region (208), as the second set of light rays (310).

It must be noted herein that, the refractive side (306), the reflective side (304) and the reflective plane (308) may enable the second optical region (206) to simultaneously refract and reflect the first set of light rays (204). Such arrangement facilitates in exiting of the light rays from a region other than a single exit facet in conventional applications, which enables in widening the illumination area in front of the vehicle and thereby achieve uniform light homogeneity.

FIG. 4 illustrates an expanded view (400) of a third optical region (208) of the light guide, in accordance with an embodiment of the present subject matter. As shown, the third optical region (208) may comprise a reflective region (410) comprising a plurality of reflective elements (402) and (404). In one embodiment, the reflective element (402) may be configured to receive and reflect the second set of light rays (310) as a third set of light rays (408). Further, the third set of light rays (408) successfully exits the third optical region through the exit facet (210) as exiting light rays (406).

In one embodiment, the reflective element (404) may be configured to receive and reflect the second set of light rays (310) towards an internal reflective surface of the third optical region (208), as a third set of light rays (408). Further, after multiple successive reflections, the third set of light rays (408) may pass through the exit facet (210) as exiting light rays (406).

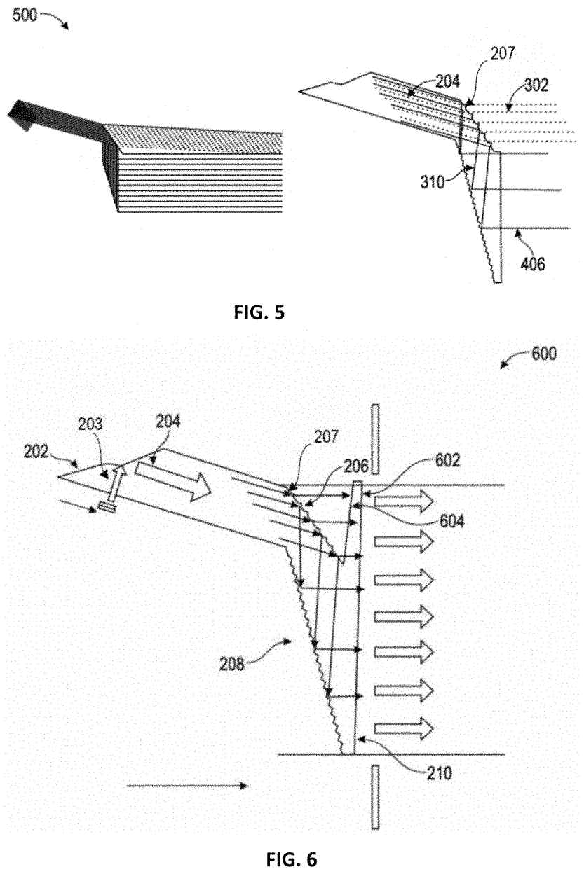

FIG. 5 depicts a ray diagram (500) of the light rays in the light guide, in accordance with an embodiment of the present subject matter. As can be seen, the incident light rays (203) from the light incident region (212) may be collimated and reflected by the first optical region (202) towards the second optical region (206). Further, the second optical region (206) may be configured to refract a first portion of the first set of light rays (204) towards the exit facet (207). The second optical region (206) may be further configured to reflect a second portion of the first set of light rays to the third optical region (208), as a second set of light rays. Further, the third optical region (208) may reflect the second set of light rays towards the exit facet (210) of the third optical region (208).

Referring to FIG. 6, a sectional view (600) of the light guide coupled with an optical element (602) is illustrated, in accordance with an embodiment of the present subject matter. In this embodiment, the light guide may further include an optical element (602) in addition to the first optical region (202), the second optical region (206), and the third optical region (208). The optical element (602) may further include an optical surface positioned in front of the second optical region (206). In one embodiment, the optic surface (604) may be positioned in front of the exit facet (207) of the second optical region (206).

In one embodiment, the optic surface (604) may include a light diffusing surface, wherein the light diffusing surface may enable refraction of light rays passing through the optical element (602). Further, the optic surface (604) may be configured to receive the exiting first portion (204(a)) of the first set of light rays from the second optical region (206), and refract the exiting first set of light rays (204) such that the exiting rays are parallel to the exiting light rays (406) exiting from exit facet (210) of the third optical region (208).

In an embodiment, the first portion (204(a)) of the first set of light rays (204) exiting through an exit facet (207) of the second optical region (206) and the second set of light rays (310) exiting an exit facet (210) of the third optical region (208) as the exiting light rays (406) collectively forms final exiting light rays to illuminate an area in front of the lamp.

Exemplary embodiments discussed above may provide certain advantages. Though not required to practice aspects of the disclosure, these advantages may include those provided by the following features.
Some embodiments of the present disclosure enable a light guide having multiple facets for exiting light thereby widening the lit area of the lighting and/or signalling device in the motor vehicle.
Some embodiments of the present disclosure enable a light guide emitting a uniform light beam to a wider area.
Some embodiments of the present disclosure enable a light guide being manufactured as a single part structure thereby facilitating an ease of assembling the light guide in lighting and/or signalling device within the two/three/four wheel motor vehicles.
Some embodiments of the present disclosure enable a light guide requiring less material for manufacturing and more areas for PCB placement thereby facilitating reduction on overall cost of the light guide and less bulky design.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

The foregoing description shall be interpreted as illustrative and not in any limiting sense. A person of ordinary skill in the art would understand that certain modifications could come within the scope of this disclosure. The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

Although implementations for the lighting and/or signaling device for a motor vehicle have been described in language specific to structural features and/or methods, it is to be understood that the appended claims are not necessarily limited to the specific features or methods described. Rather, the specific features and methods are disclosed as examples of implementations for the lighting and/or signaling device for a motor vehicle.

1. A lighting and/or signaling device for a motor vehicle, comprising:
at least one light guide, the said light guide comprising
a light incident region;
a first optical region, wherein the first optical region is configured to receive incident light rays from the light incident region, and redirect the incident light rays towards downstream direction as a first set of light rays;
a second optical region provisioned with an optical structure, wherein the second optical region is arranged downstream to the first optical region, wherein the second optical region is configured to receive the first set of light rays, and wherein the optical structure of the second optical region is configured to refract a first portion of the first set of light rays towards an exit facet and simultaneously configured to reflect a second portion of the first set of light rays towards downstream direction as a second set of light rays; and
a third optical region, wherein the third optical region is arranged downstream to the second optical region, wherein the third optical region is configured to receive the second set of light rays and reflect the said second set of light rays towards an exit facet as an exiting light rays.

2. The device as claimed in claim 1, wherein the second optical region and the third optical region are enabled with a total internal reflection surfaces, wherein the total internal reflection surfaces are configured to reflect the light rays towards the downstream direction.

3. The device as claimed in claim 1, wherein the optical structure is formed by an array of triangular prismatic structure, wherein the triangular prismatic structure comprises a reflective side, a refractive side and a reflective plane, wherein the reflective side and the refractive side are separated by the reflective plane.

4. The device as claimed in claim 1, wherein the device further comprises an optical element, wherein the optical element comprises an optic surface positioned in front of the exit facet of the second optical region, wherein the optic surface is configured to receive the first portion of first set of light rays from the exit facet of the second optical region.

5. The device as claimed in claim 4, wherein the optic surface comprises a light diffusing surface, wherein the light diffusing surface is configured to refract the first portion of the first set of light rays exiting from the exit facet of the second optical region parallel to the exiting light rays exiting from exit facet of the third optical region.

6. The device as claimed in claim 1, wherein the third optical region comprises an optical structure, wherein the optical structure comprises a plurality of reflective elements.

7. The device as claimed in claim 6, wherein the second set of light rays is reflected by the reflective element as a third set of light rays, and wherein the third set of light rays successfully exits the third optical region through the exit facet, of the third optical region, as the exiting light rays.

8. The device as claimed in claim 6, wherein the second set of light rays is reflected by the reflective element as a third set of light rays, wherein the third set of light rays undergoes successive multiple reflections by the internal reflective surface of the third optical region and exits through the exit facet, of the third optical region, as exiting light rays.

9. The device as claimed in claim 1, wherein the first portion of the first set of light rays exiting through an exit facet and the second set of light rays exiting an exit facet as an exiting light rays collectively forms exiting light rays to illuminate an area in front of the lamp.

10. A light guide for a lighting and/or signaling device of a motor vehicle, comprising:
a light incident region;
a first optical region, wherein the first optical region is configured to receive incident light rays from the light incident region, and redirect the incident light rays towards downstream direction as a first set of light rays;
a second optical region provisioned with an optical structure, wherein the second optical region is arranged downstream to the first optical region, wherein the second optical region is configured to receive the first set of light rays, and wherein the optical structure of the second optical region is configured to refract a first portion of the first set of light rays towards an exit facet and simultaneously configured to reflect a second portion of the first set of light rays towards downstream direction as a second set of light rays; and
a third optical region, wherein the third optical region is arranged downstream to the second optical region, wherein the third optical region is configured to receive the second set of light rays and reflect the said second set of light rays towards an exit facet as an exiting light rays.

11. The light guide as claimed in claim 10, the second optical region and the third optical region are enabled with a total internal reflection surfaces, wherein the total internal reflection surfaces are configured to reflect the light rays towards the downstream direction.

12. The light guide as claimed in claim 10, wherein the optical structure is formed by an array of triangular prismatic structure, wherein the triangular prismatic structure comprises a reflective side, a refractive side and a reflective plane, wherein the reflective side and the refractive side are separated by the reflective plane.

13. The light guide as claimed in claim 10, wherein the light guide further comprises an optical element, wherein the optical element comprises an optic surface positioned in front of the exit facet of the second optical region, wherein the optic surface is configured to receive the first portion of first set of light rays from the exit facet of the second optical region.

14. The light guide as claimed in claim 13, wherein the optic surface comprises a light diffusing surface, wherein the light diffusing surface is configured to refract the first portion of the first set of light rays exiting from the exit facet of the second optical region parallel to the exiting light rays exiting from exit facet of the third optical region.

15. The light guide as claimed in claim 13, wherein the third optical region comprises an optical structure, wherein the optical structure comprises a plurality of reflective elements.

16. The light guide as claimed in claim 15, wherein the second set of light rays is reflected by the reflective element as a third set of light rays, and wherein the third set of light rays successfully exits the third optical region through the exit facet, of the third optical region, as the exiting light rays.

17. The light guide as claimed in claim 15, wherein the second set of light rays is reflected by the reflective element as a third set of light rays, wherein the third set of light rays undergoes successive multiple reflections by the internal reflective surface of the third optical region and exits through the exit facet, of the third optical region, as exiting light rays.

18. The light guide as claimed in claim 11, wherein the first portion of the first set of light rays exiting through an exit facet of the second optical region and the second set of light rays exiting an exit facet of the third optical region as an exiting light rays collectively forms exiting light rays to illuminate an area in front of the lamp.
